(19) United States
(12) Patent Application Publication
(10) Pub. No.: US 2014/0108022 A1
(43) Pub. Date: Apr. 17, 2014

(54) Brokerage System Employing Minimal Criteria Matching and Availability Queuing

(71) Applicant: AMERICAN WELL SYSTEMS, Boston, MA (US)

(72) Inventor: Roy Schoenberg, Boston, MA (US)

(73) Assignee: AMERICAN WELL SYSTEMS, Boston, MA (US)

(21) Appl. No.: 13/650,309

(22) Filed: Oct. 12, 2012

(51) Int. Cl. G06Q 50/22

(52) U.S. Cl. 705/2

(57) ABSTRACT

Techniques are disclosed for connecting consumers of services with providers of services. The techniques include receiving from a device used by a consumer a request to engage in a consultation with a service provider, retrieving current availability information for a plurality of service providers that indicate the service providers' current availability to engage a consumer, analyzing by the one or more computers the current availability of the service providers and causing the one or more computers to select one of the service providers that according to the analysis has the least number of consumers currently in that service provider's virtual waiting room.

### BACKGROUND

Systems have been developed to connect consumers and their providers over the Internet and the World Wide Web. Some systems use e-mail messaging and web-based forms to increase the level of connectivity between a member of a health plan and his assigned health care provider. The consumer sends an e-mail or goes to a website that generates and sends a message (typically an e-mail or an e-mail type message) to a local provider.

These types of services have been broadly referred to as “e-visits.” While generally viewed as an addition to the spectrum of services that may be desired by consumers, the benefits of such services are not clear. One of the concerns associated with offering additional communication channels, such as e-mail, is that it can result in over consumption of services, rather than provide for better coordination.

Another system is a brokerage type of system as described in my issued Patent U.S. Pat. No. 7,590,550, the contents of which are incorporated herein by reference.

### SUMMARY

According to an aspect, a computer-implemented method includes receiving by one or more computers from a device used by a consumer a request to engage in a consultation with a service provider, retrieving by the one or more computers current availability information for a plurality of service providers that indicate the service providers' current availability to engage a consumer, analyzing by the one or more computers the current availability of the service providers, and causing the one or more computers to select one of the service providers that according to the analysis has the least number of consumers currently in that service provider's virtual waiting room.

According to an additional aspect, a computer-implemented method includes receiving by one or more computers from a device used by a consumer a request to engage in a consultation with a service provider, accessing by the one or more computers queues associated with service providers who are available to provide the consultation, with a queue for a particular service provider being populated with entries that represent consumers who desire to have consultations with the particular service provider, identifying from the accessed queues a queue of a suitable service provider that has a decreased number of entries waiting to be processed, relative to numbers of entries in other of the accessed queues, and populating though the one or more computers the identified queue with an entry for the consumer requesting the consultation.

According to an additional aspect, a computer program product tangibly stored on a computer readable storage device for connecting consumers of services with service providers includes instructions for causing a processor to receive from a device used by a consumer a request to engage in a consultation with a service provider, retrieve current availability information for a plurality of service providers that indicate the service providers' current availability to engage a consumer, analyze the current availability of the service providers, and cause a selection one of the service providers that according to the analysis has the least number of consumers currently waiting to engage with that service provider.

According to an additional aspect, a computer system includes one or more processor devices, memory associated with the one or more processor devices, and a computer readable storage device storing a computer program product for connecting consumers of services with service providers comprises instructions for causing the one or more processor devices to receive from a device used by a consumer a request to engage in a consultation with a service provider, retrieve current availability information for a plurality of service providers that indicate the service providers' current availability to engage a consumer, analyze the current availability of the service providers, and cause a selection one of the service providers that according to the analysis has the least number of consumers currently waiting to engage with that service provider.

One or more aspects may include one or more of the following features. Other features may also be included.

Features can include sending to one or more consumer computers a pre-intake questionnaire. Features can include generating a graphical user interface that when rendered on a display device renders a visual representation of the virtual waiting room, the visual representation comprising a depiction of information regarding consumers in the virtual waiting room. Features can include generating the graphical user interface to further include a visual indicator of an amount of time a patient has been waiting in the virtual waiting room. Assigning queues to providers currently logged into the system. Features can include determining by the one or more computers a number of entries in queues of the providers currently logged in the system. Availability types for a provider include at least one of “available-web”, “available-telephone”, “busy-waiting room open”, “on-call” and “unavailable appointments only.” Features can include assigning a set of queues to providers currently logged into the system, each queue in a set of queues corresponding to a different availability status of the provider. Features can include establishing a communication channel between the selected service provider and a consumer requesting a consultation. A service provider is considered currently available when associated with one or more of an available-web state, an available-telephone state, a busy-waiting room open state, an on-call state, and a busy state. Features can include determining that the entry for the consumer requesting the consultation is first in the identified queue and causing a communication channel to be established between the device used by the consumer and a device used by the service provider associated with the identified queue.

One or more advantages may be provided by one or more aspects including that suitable physicians are determined either based on extensive matching of criteria desired by the patient or simplified matching meaning that aside from using relatively basic matching criteria, such as proper licensure and insurance network, little other matching is provided with selection of a suitable physician based on contents of physician queues to thus minimize delays and provide a more robust system able to service clients possibly at a lower cost.

The details of one or more implementations are set forth in the accompanying drawings and the description below. Other features, objects, and advantages will be apparent from the description and drawings, and from the claims.

### DESCRIPTION OF DRAWINGS

FIG. 1 is a diagrammatic view of an engagement brokerage service.

FIG. 2 is a screenshot of a graphical user interface that when rendered on a display device renders a visual representation of a waiting room.

FIG. 3 is a flow chart of a process for facilitating patient in the system of FIG. 1.

FIG. 4 is a flow chart of a process for tracking availability.

FIGS. 5A-5C are block diagrams of queue structures that can be used for the brokerage system.

FIG. 5B is a flow chart depicting provider selection.

FIG. 6 is a flow chart of a process used in the system of FIG. 1.

FIG. 7 is a block diagram of typical components that can be used for various ones of the devices shown in the system of FIG. 1.

### DETAILED DESCRIPTION

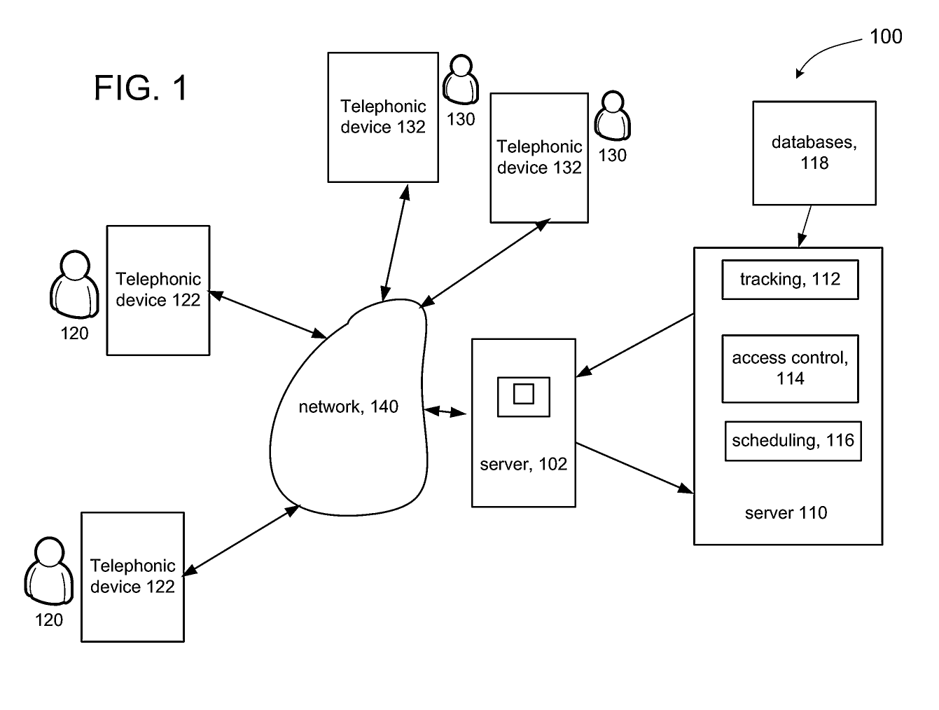

Referring now to FIG. 1 an exemplary system 100 implementing a brokerage service is shown. The system 100 includes a computer system or server 110 for making connections between consumers 120, at client systems 122, including mobile devices and PDAs, and service providers 130, at client systems 132, over a network 140, e.g., the Internet or other types of networks. In some embodiments, the computer system 110 operates as a service running on a web server 102.

The computer system 110 includes an availability or presence tracking module 112 for tracking the availability of the service providers 130. Availability or presence is tracked actively or passively. In an active system, one or more of the service providers 130 provides an indication to the computer system 110 that the one or more service providers are available to be contacted by consumers 120 and an indication of the mode by which the provider may be contacted.

In some examples of an active system, the provider's mobile device periodically provides an indication of the provider's availability (e.g., available, online, idle, busy) to the system 110 such as through a provider selection. The active system also can provide an indication of a mode (e.g., text, voice, video, etc.) by which the provider can engage. More specifically, a provider can have specific types of current availability such as “available-web”, “available-telephone”, “busy-waiting room open”, “busy-wait for consultation”, “on-call” and “unavailable appointments only.”

In a passive system, the computer system 110 presumes that the service provider 130 is available by the service provider's actions, including connecting to the computer system 110 or registering the provider's local phone number of the provider's mobile device with the system. In some examples of a passive system, the system 110 indicates the provider 130 to be available at all times until the provider logs off, except when the provider is actively engaged with a consumer 120. More specifically, in a passive system a provider can still have specific types of current availability such as “available-web”, “available-telephone”, “busy-waiting room open”, “on-call” and “unavailable appointments only.”

The computer system 110 also includes one or more processes such as the tracking module 112 and a scheduling module 116. The system 110 accesses one or more databases 118. The components of the system 110 and the web server 102 may be integrated or distributed in various combinations, as is commonly known in the art.

Using the system 100, a consumer 120 communicates with a provider 130. The consumers 120 and providers 130 connect to the computer system 110 through a graphical user interface displayed on a mobile device and served by the web server 102 using client devices 122 and 132, respectively. Client devices 122 and 132 include any combination of mobile devices, PDAs, cellular phones, computer systems, and so forth. The client devices 122 and 132 enable the consumers 120 to input and receive information as well as to communicate via video, audio, and/or text with the providers 130. An exemplary system will be one used to broker engagements between physicians (providers) and patients (consumers). The features discussed herein however can be adapted to any type of engagement.

In some implementations, the system allows providers of services, e.g., physicians, to integrate interactions with the brokerage system 100 with their physical practice (e.g., patients seen in a physician's physical office), allowing service providers the flexibility to seamlessly manage their virtual practice while caring for patients in their physical practice. Providers integrate their physical practices with the brokerage system 100 into the providers' respectively, existing office hours. Through the system, providers leverage their existing administrative support staff and designate other providers in the practice to provide coverage to patients seeking care, when a particular provider is unavailable.

Another component of the system includes an appointment scheduler, through which users manage appointments for physicians, including, e.g., by cancelling appointments from a physician's calendar, by adding appointments to the physician's calendar, and so forth.

Waiting room

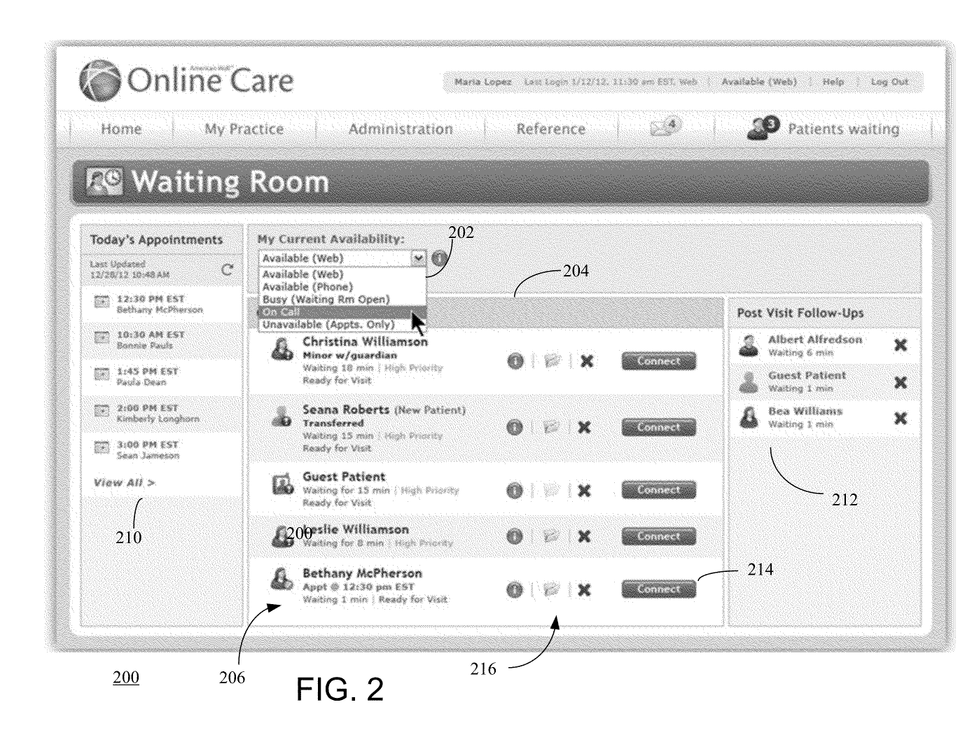

Referring now to FIG. 2, in another embodiment, the physician indicates his availability. The physician when logged in will be presented with a screen 200 that has choices 202 for current availability. The physician selects one of those choices. Exemplary choices include “available-web”, “available-telephone”, “busy-waiting room open”, “on-call” and “unavailable appointments only.” In particular, a patient can be placed into a virtual waiting room 204; in which entries 206 corresponding to patients are placed in one or more queues (not shown) to wait for a physician that is engaged with another patient. The waiting room portion 204 of the graphical user interface renders a listing of some or all of the patients waiting in the waiting room for the physician. In particular, there are three panes in this exemplary interface, a listing of today's appointments 210, a listing of patients in the waiting room 204 and a list 212 of post visit follow-ups.

For each patient that is placed in the waiting room, the waiting room pane 204 has an entry that displays information pertaining to the patient, including, e.g., the patient's name, the patient's status, the patient's availability status (optionally whether the patient has a previous relationship with this physician or not), how long the patient has been waiting, and so forth. With each entry in the listing of patients in the waiting room there is a connect button 214 that establishes a real-time connection with the patient, as well as controls 216 to delete the entry, store the entry, and ask further information about the entry.

Another graphical user interface (not shown) associated with the waiting room can provide a physician with additional patient information, including, e.g., a patient summary, which includes topics to discuss, responses to triage questions, and the patient's health summary, an interface through which a user engages in a text chat with the patient to solicit additional information and to prepare the patient for an upcoming visit with the physician, an interface through which the user takes notes about the patient that may be helpful for the physician to review prior to engaging in a conversation with the patient, an interface through which the user may remove the patient from the waiting room, and so forth.

If the physician's ability to see patients, changes, or the physician becomes too busy in the regular practice, the waiting room includes a control device through which users control the volume of patients entering the waiting room by opening/closing the waiting room doors to patients with whom the physician does not have a previous relationship. The virtual waiting room generated by a computer system is closed by the computer system to admittance of new patients based on the computer system determining that the number of existing physician appointments exceeds some preset value. The value can be the number of patients that the physician will see over the course of the day or over an interval of time.

In an example, the physician's schedule is fully booked except for one opening in the physician's schedule. A walk-in patient that is waiting for the single, open appointment is placed in the waiting room. At this point, the physician's schedule is fully booked and the physician cannot see any additional patients. Accordingly, the computer system closes the physician's waiting room to the admittance of new patients. Additionally, the physician's waiting room may also be closed based on the physician's availability status. For example, if the physician has an availability status of “busy” or otherwise unavailable, the computer system closes the physician's waiting room.

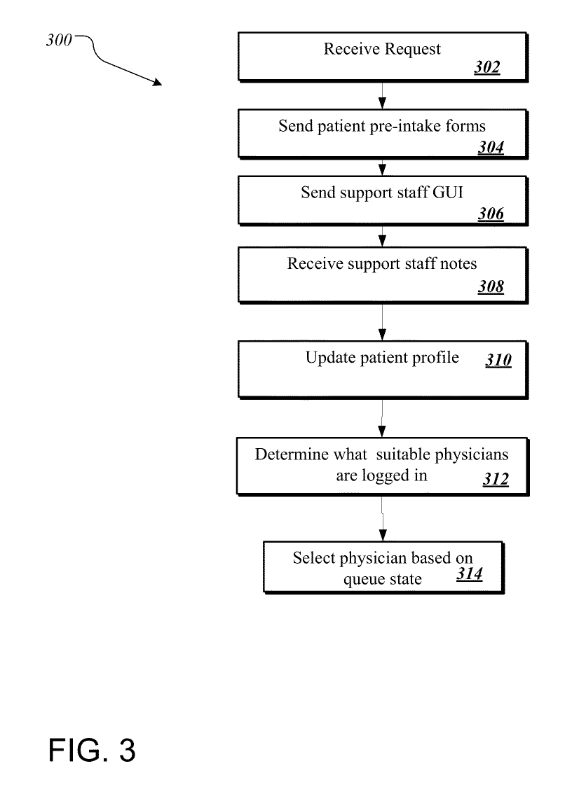

Referring now to FIG. 3 a process 300 for facilitating patient assignment to physicians is shown. In operation system 100 receives (302) a request from a patient for a consultation with a physician. System 100 sends (304) pre-intake forms, including, e.g., questionnaires, to a computing device associated with the patient. The patient completes the pre-intake forms and sends the pre-intake forms back to server 100. System 100 also sends (306) a support staff graphical user interface to computing devices associated with a practice. The support staff graphical user interface includes questions for support staff (e.g., nurses, administrative assistants, and so forth) to fill out prior to the patient's consultation with the physician.

In response to sending the support staff graphical user interface, system 100 receives (308) support staff notes, including, e.g., answers to questions included in the support staff graphical user interface. Using the received support staff notes and the patient's answers to the questionnaires, system 100 updates or produces (310) a patient's profile.

System 100 determines (312) what suitable physicians are currently logged into the brokerage system, for example, to consult with patients. The system determines (314) suitable physicians for the patient. In one embodiment, extensive matching of criteria, e.g. attributes of the physician that are desired by the patient and which are specified by the patient during, e.g., intake. The system performed this matching by searching for providers that possess the desired attributes.

However, in other embodiments, the matching is simplified, meaning that aside from using relatively basic matching criteria, such as proper licensure and insurance network, little other matching is provided and rather that asking for a selection of physician from the patient, a different process is used. Selection of a physician is made based on contents of physician queues, as discussed below.

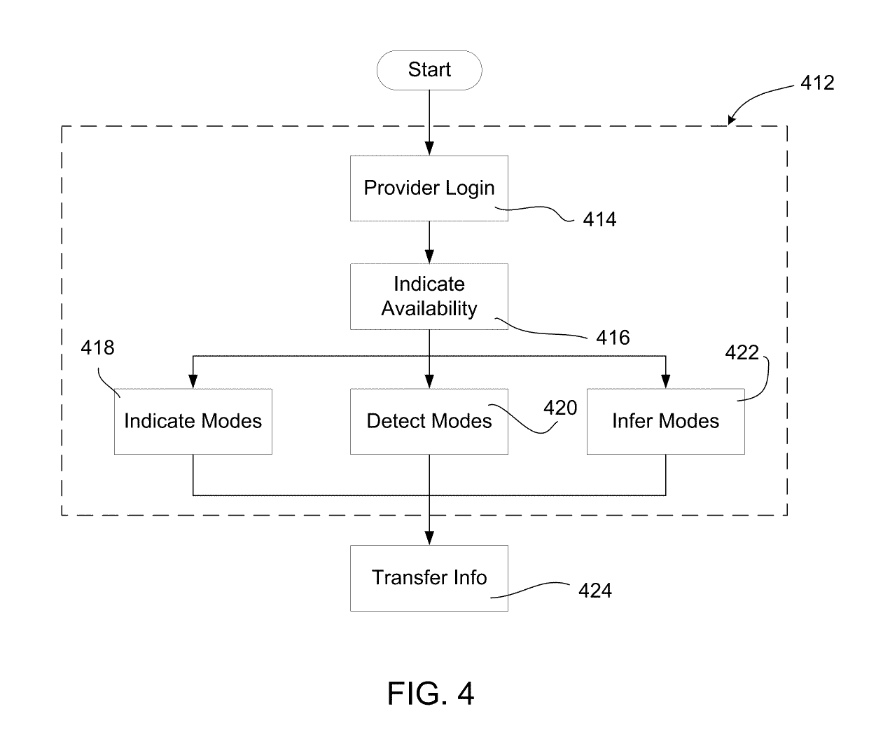

Referring now to FIG. 4, the server 110 tracks 412 the availability of physicians 130 and in some embodiments, on-line patients 120. When a physician 130 logs 414 into the networked computer system 100, the physician 130 indicates 416 (such as by setting a check box or selecting a menu entry or by responding to a voice prompt) to the tracking module 112 that he or she is available to interact with patients 120. The physician 130 can also indicate 418 to the tracking module 112 (such as by setting a check box or selecting a menu entry or by responding to a voice prompt) the modes (e.g., telephone, chat, video conference) by which a patient 120 can be connected to the physician 130.

The tracking module 114 can determine 420 the capabilities of the terminals 122 and 132 the patient 120 and the physician 130 use to connect to the system (for example, by using a terminal-based program to analyze the hardware configuration of each terminal). Thus, if a physician 130 connects to the networked computer system 100 by a desktop computer and the physician has a video camera connected to that computer, the tracking module 112 determines 420 that the physician 130 can be engaged by text (e.g., chat or instant messenger), voice (e.g., VoIP) or video conference. Similarly, if a physician 130 connects to the system using a handheld device such as a PDA, the tracking module 112 determines 422 that the physician 130 can be engaged by text or voice.

The tracking module 112 can also infer 422 a physician's availability and modes of engagement by the physician's previously provided profile information and the terminal device through which the physician connects to the system. Physicians participating in the brokerage network can have several states of availability over time. States in which the physician may be available include available “web”, in which the physician is logged-in and can immediately accept new engagements in any mode, “available (phone)”, in which the physician is logged-in but can accept phone engagements “busy (waiting room open)” in which the physician is currently occupied in another engagement but is accepting new patients in a waiting room, and “unavailable”, in which the physician is offline but is scheduled to be online at a designated time-point and can pre-schedule engagements for it.

The operating business model for the physician network employs a remuneration scheme for physicians that helps assure that the patients can find physicians in designated professional domains in the online mode. For example, selected physicians can be remunerated for being in the on-call mode to encourage on-line availability in case of low discretionary availability by other physicians in their professional domain. On-call physicians are also called into the on-line state when the fraction of on-line (busy) physician's domain exceeds a certain threshold.

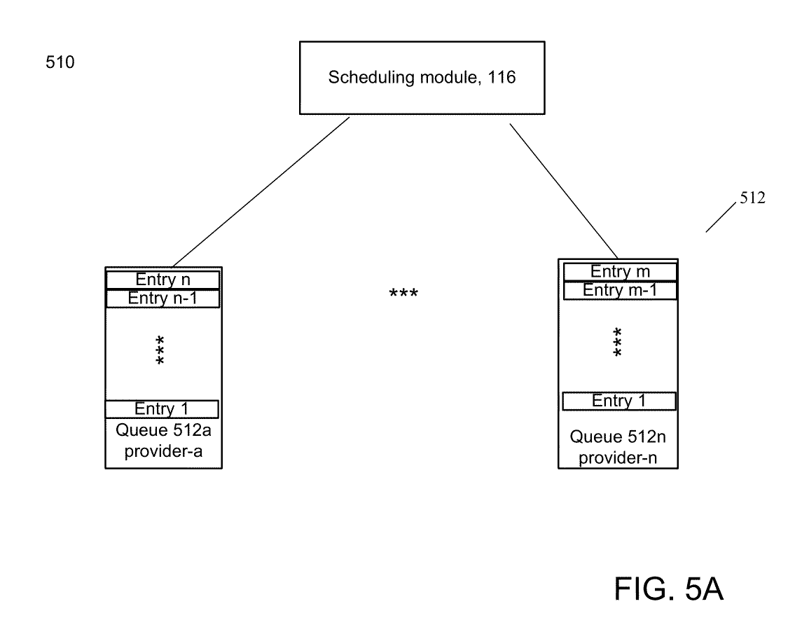

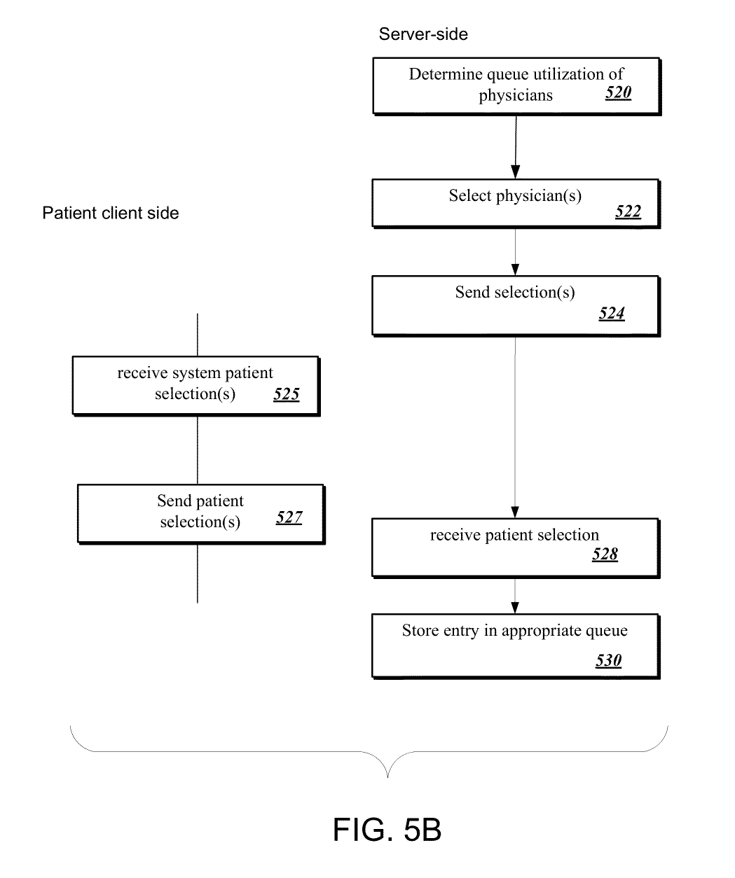

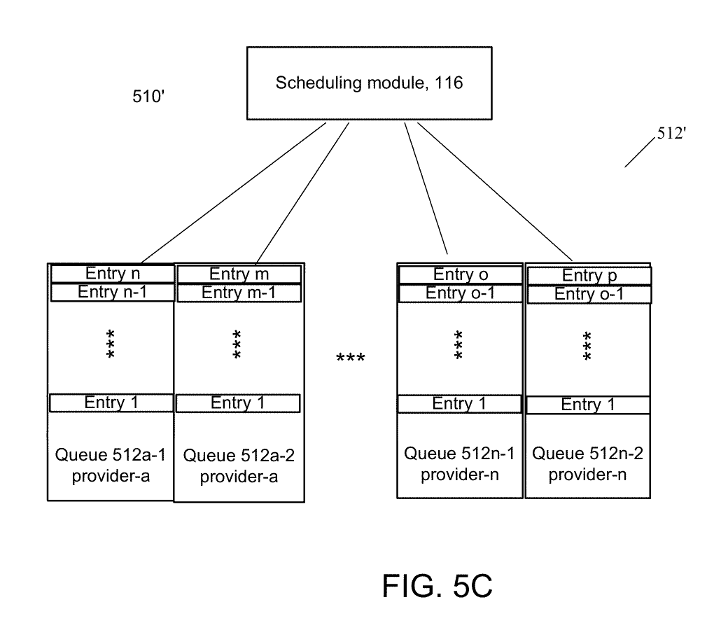

Referring now to FIG. 5A, the tracking module 112 (FIG. 1) transfers 154 (FIG. 4) information about the availability and the communication capabilities of the patients 120 and the physicians 130 to the scheduling module 116. The scheduling module 116 uses the tracking information to schedule physicians with patients.

In one scheduling algorithm 510, each physician is associated with a queue, e.g., 512a-512n for physician a to physician n. The queue for each physician is populated by the server 110 with entries (as depicted as entries n and entries m) that represent patients that desire to have consultations with a physician. More specifically, as patients access the networked computer system 100 and are processed through the intake process, entries representing the patients are produced by the server 110 and those entries are queued.

Referring now to FIG. 5B, the server examines 518 the queues of suitable physicians that meet either extensive or minimal matching criteria embodiment. In one implementation, the server 110 examines the queues 512a - 512n of all physicians that are suitable to provide a consultation with the patient with suitability determined using the minimal criteria matching discussed above, and the server chooses the queue of a suitable physician (or queues of several physicians) that has the least number of entries waiting to be processed, e.g., a decreased number of entries relative to the numbers of entries in other queues.

The server determines 520 which queues of those physicians are least occupied. From the physicians with the least occupied queues, the system selects 522 one or possibly more physicians and sends 524 the selection to the patient. Through a graphical user interface the patient can select 525 the one or select from among the more than one physician which the system selected from based on queue “emptiness” and send 527 the selection to the server 110. The selection is received 528 by the server. The server 110 stores 530 the entry corresponding to the consumer selected physician in the corresponding one of the queues (generally 512) of that physician. By the server determining suitable physicians based on queue “emptiness,” e.g., the least number of entries, this enables balancing of physician utilization across the system 100, and to otherwise minimizes overall response time for patients.

The server 110 will use a first in first out priority scheme to retrieve records from the query in order to furnish information to physicians for servicing clients.

As an example, a request is received by the server 110, the server 110 determines that the, queue 512a of “physician-a” has the least number of entries and thus an entry E₁ is loaded into the queue 512a. In servicing patient requests, for a particular physician, the server 110 retrieves the entry of a patient that is next to be serviced (generally the oldest entry in the queue 512). As the physician services that patient, the server 110 removes the corresponding entry from that physician's queue and then the server 110 promotes all remaining entries in that queue such that the next entry in the queue to be serviced will be now be the oldest entry.

Referring now to FIG. 5C, in an alternative embodiment 510′ the queues (generally 512′) for each physician are sub-divided or represented as plural sub-queues with each of the sub-queues corresponding to an appointment “state.” In FIG. 5C, two queues 512a-1 to 512a-2 and 512n-1 to 512n-2 are shown for each of the physicians, e.g., “physician a” to “physician n” with the sub-queues 512a-1 to 512a-2 and 512n-1 to 512n-2 representing, “waiting room” and “scheduled appointments” of the respective physicians “physician a” to “physician n.” However, in other embodiments additional sub-queues can be provided to corresponding to some or all of the availability statuses of a provider, such as discussed above in conjunction with FIG. 2.

In this embodiment, the server using scheduling module 116, examines the queues 512′ of all physicians that are suitable (again based on minimal criteria matching) to provide a consultation with the patient and chooses the appropriate sub-queue of a suitable physician that has the least number of entries waiting to be processed for the particular state, e.g., “waiting room” and “scheduled appointments.” More specifically, the server loads entries into the waiting room queue of the particular physician that has the fewest entries.

In servicing requests, for a particular physician, the system retrieves the entry of a patient that is next to be serviced from the waiting room for that physician. The next to be serviced is according to the following priority the oldest entry in the waiting room, unless the server determines that the scheduled appointment queue of the physician has an entry for a scheduled appointment that has an scheduled appointment time that is either equal to the current time or would be within a time window where the servicing of a waiting room entry or a new request would adversely impact servicing of scheduled appointment queued entry. For example, in some embodiments the system 100 could allocate a set time period of, e.g., 15 minutes to service a request. Accordingly, the server 110 would not select an entry from the waiting room queue if there was a scheduled appointment in, e.g., 10 minutes. As the physician services a patient from its sub-queue all remaining entries (representing other patients) in that sub-queue are promoted such that the next entry in the sub-queue to be serviced will be the next oldest entry.

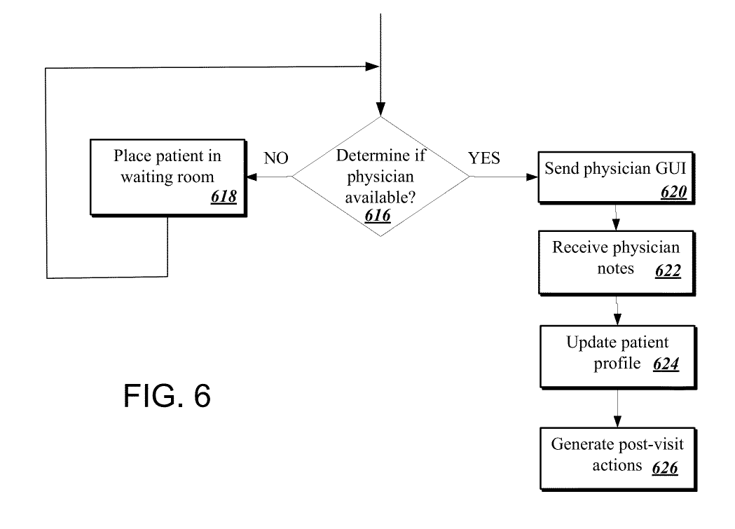

Referring now to FIG. 6, system 100 determines (616) whether the system selected physician (from FIG. 3) is currently available for a consultation with the patient. If the physician is not currently available, system 100 places (618) the patient in a queue such as a waiting room queue or another queue. If the physician is currently available, the brokerage system establishes (not shown) a communication channel between the selected physician and the patient and the system 100 sends (620) a physician graphical user interface to a computing device associated with the physician. In an example, system 100 determines that the physician is currently available for a consultation with a patient, when an entry for that patient is first in the queue of that physician. The physician graphical user interface includes text fields and boxes into which the physician can enter notes and assessments regarding the patient.

In response to sending the physician graphical user interface, system 100 receives (622) physician notes regarding the patient. System 100 updates (624) the patient's profile using the physician notes. Additionally, using the physician notes, system 100 generates (626) post visit follow-up actions.

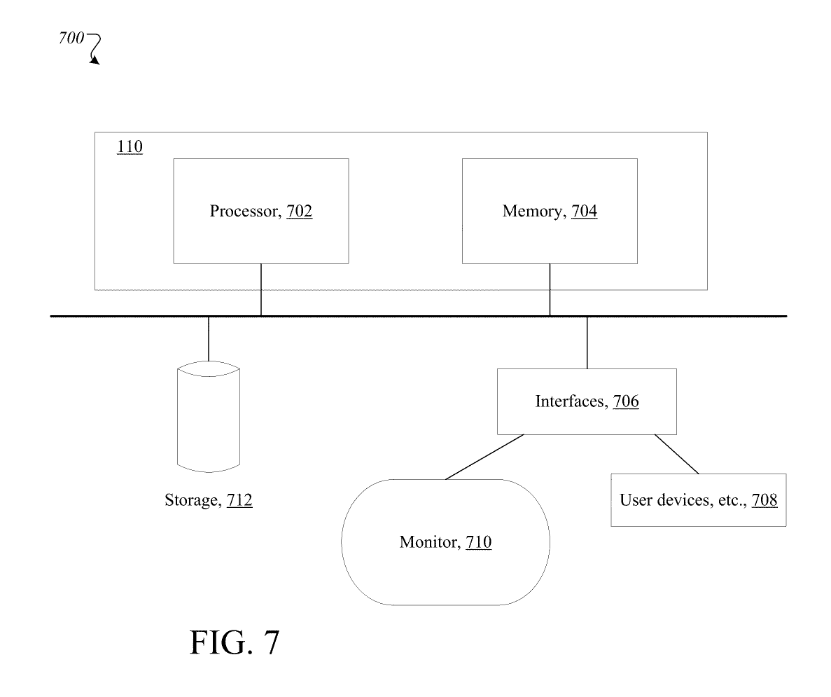

FIG. 7 shows details of components used in the engagement brokerage system 100. Systems and user devices will typically include a processor 702, memory 704, interfaces 706, storage 712, monitor 710, and user interface devices 708 such as a mouse, etc. User devices can be any sort of computing device capable of taking input from a user and communicating over a network (not shown) with server 110 and/or with other client devices. For example, user devices can be a mobile device, a desktop computer, a laptop, a cell phone, a personal digital assistant (“PDA”), a server, an embedded computing system, a mobile device and so forth. User devices can include a monitor that renders visual representations.

Server 110 can be any of a variety of computing devices capable of receiving information, such as a server, a distributed computing system, a desktop computer, a laptop, a cell phone, a rack-mounted server, and so forth. Server 110 may be a single server or a group of servers that are at a same location or at different locations. Server 110 can receive information from user device, including, e.g., graphical user interfaces. Interfaces 706 can be any type of interface capable of receiving information over a network, such as an Ethernet interface, a wireless networking interface, a fiber-optic networking interface, a modem, and so forth. Server 110 also includes a processor 702 and memory 704. A bus system (not referenced) can be used to establish and to control data communication.

Processor 702 may include one or more microprocessors. Generally, processor 702 may include any appropriate processor and/or logic that is capable of receiving and storing data, and of communicating over a network (not shown). Memory 704 can include a hard drive and a random access memory storage device, such as a dynamic random access memory, machine-readable media, or other types of non-transitory machine-readable storage devices. Components 700 also include storage device 712, which is configured to store information collected through the brokerage system during a physician's consultation with a patient, as well as an operating system and application software.

Embodiments can be implemented in digital electronic circuitry, or in computer hardware, firmware, software, or in combinations thereof. Apparatus of the invention can be implemented in a computer program product tangibly embodied or stored in a machine-readable storage device and/or machine readable media for execution by a programmable processor; and method actions can be performed by a programmable processor executing a program of instructions to perform functions and operations of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

Other embodiments are within the scope and spirit of the description claims. For example, due to the nature of software, functions described above can be implemented using software, hardware, firmware, hardwiring, or combinations of any of these. Features implementing functions may also be physically located at various positions, including being distributed such that portions of functions are implemented at different physical locations.

What is claimed is:

1. A computer-implemented method comprising:
receiving by one or more computers from a device used by a consumer a request to engage in a consultation with a service provider;
retrieving by the one or more computers current availability information for a plurality of service providers that indicate the service providers' current availability to engage a consumer;
analyzing by the one or more computers the current availability of the service providers; and
causing the one or more computers to select one of the service providers that according to the analysis has the least number of consumers currently in that service provider's virtual waiting room.

2. The computer-implemented method of claim 1 further comprising:
sending to one or more consumer computers an pre-intake questionnaire.

3. The computer-implemented method of claim 1, further comprising:
generating a graphical user interface that when rendered on a display device renders a visual representation of the virtual waiting room, the visual representation comprising a depiction of information regarding consumers in the virtual waiting room.

4. The computer-implemented method of claim 3, further comprising:
generating the graphical user interface to further include a visual indicator of an amount of time a patient has been waiting in the virtual waiting room.

5. The computer-implemented method of claim 1, further comprising:
assigning queues to providers currently logged into the system.

6. The computer-implemented method of claim 1, further comprising:
determining by the one or more computers a number of entries in queues of the providers currently logged in the system.

7. The computer-implemented method of claim 1 wherein availability types for a provider include at least one of “available-web”, “available-telephone”, “busy-waiting room open”, “on-call” and “unavailable appointments only.”

8. The computer-implemented method of claim 1, further comprising:
assigning a set of queues to providers currently logged into the system, each queue in a set of queues corresponding to a different availability status of the provider.

9. The computer-implemented method of claim 1, further comprising:
establishing a communication channel between the selected service provider and a consumer requesting a consultation.

10. The computer-implemented method of claim 1, wherein a service provider is currently available when associated with one or more of an available-web state, an available-telephone state, a busy-waiting room open state, an on-call state, and a busy state.

11. A computer-implemented method comprising:
receiving by one or more computers from a device used by a consumer a request to engage in a consultation with a service provider;
accessing by the one or more computers queues associated with service providers who are available to provide the consultation, with a queue for a particular service provider being populated with entries that represent consumers who desire to have consultations with the particular service provider;
identifying from the accessed queues a queue of a suitable service provider that has a decreased number of entries waiting to be processed, relative to numbers of entries in other of the accessed queues; and
populating though the one or more computers the identified queue with an entry for the consumer requesting the consultation.

12. The method of claim 11, further comprising:
determining that the entry for the consumer requesting the consultation is first in the identified queue; and
causing a communication channel to be established between the device used by the consumer and a device used by the service provider associated with the identified queue.

13. The method of claim 11, wherein a service provider is available when associated with one or more of an available-web state, an available-telephone state, a busy-waiting room open state, an on-call state, and a busy state.

14. A computer program product tangibly stored on a computer readable storage device for connecting consumers of services with service providers comprises instructions for causing a processor to:
receive from a device used by a consumer a request to engage in a consultation with a service provider;
retrieve current availability information for a plurality of service providers that indicate the service providers' current availability to engage a consumer;
analyze the current availability of the service providers; and
cause a selection one of the service providers that according to the analysis has the least number of consumers currently waiting to engage with that service provider.

15. The computer program product of claim 14, further comprising instructions to:
generate a graphical user interface that when rendered on a display device renders a visual representation of a virtual waiting room, the visual representation comprising a depiction of information regarding consumers in the virtual waiting room and an amount of time a patient has been waiting in the virtual waiting room.

16. The computer program product of claim 14, wherein the provider is a medical professional and the consumer is a patient and the product further comprises instructions to:
select the medical professional by performing minimal criterion matching, with the minimal criterion limited to either one of or both of proper licensure and insurance network.

17. The computer program product of claim 14, further comprising instructions to:
assign queues to providers currently logged into the system.

18. The computer program product of claim 14, further comprising instructions to:
determine a number of entries in queues of the providers currently logged in the system.

19. The computer program product of claim 14 wherein availability types for a provider include at least one of “available-web”, “available-telephone”, “busy-waiting room open”, “on-call” and “unavailable appointments only.”

20. The computer program product of claim 14, further comprising instructions to:
assign a set of queues to providers currently logged into the system, each queue in a set of queues corresponding to a different availability status of the provider.

21. A computer system comprising:
one or more processor devices;
memory associated with the one or more processor devices; and
a computer readable storage device storing a computer program product for connecting consumers of services with service providers comprises instructions for causing the one or more processor devices to:
receive from a device used by a consumer a request to engage in a consultation with a service provider;
retrieve current availability information for a plurality of service providers that indicate the service providers' current availability to engage a consumer;
analyze the current availability of the service providers; and
cause a selection one of the service providers that according to the analysis has the least number of consumers currently waiting to engage with that service provider.

22. The computer system of claim 21, wherein the computer program product further comprises instructions to:
generate a graphical user interface that when rendered on a display device renders a visual representation of a virtual waiting room, the visual representation comprising a depiction of information regarding consumers in the virtual waiting room and an amount of time a patient has been waiting in the virtual waiting room.

23. The computer system of claim 21, wherein the provider is a medical professional and the consumer is a patient and the computer program product further comprises instructions to:
select the medical professional by performing minimal criterion matching, with the minimal criterion limited to either one of or both of proper licensure and insurance network.

24. The computer system of claim 21, wherein the computer program product further comprises instructions to:
assign queues to providers currently logged into the system.

25. The computer system of claim 21, wherein the computer program product further comprises instructions to:
determine a number of entries in queues of the providers currently logged in the system.

26. The computer system of claim 21, wherein availability types for a provider include at least one of “available-web”, “available-telephone”, “busy-waiting room open”, “on-call” and “unavailable appointments only.”

27. The computer system of claim 21, wherein the computer program product further comprises instructions to:
assign a set of queues to providers currently logged into the system, each queue in a set of queues corresponding to a different availability status of the provider.

28. A computer program product tangibly stored on a computer readable storage device for connecting consumers of services with service providers comprises instructions for causing a processor to:
receive from a device used by a consumer a request to engage in a consultation with a service provider;
access queues associated with service providers who are available to provide the consultation, with a queue for a particular service provider being populated with entries that represent consumers who desire to have consultations with the particular service provider;
identify from the accessed queues a queue of a suitable service provider that has a decreased number of entries waiting to be processed, relative to numbers of entries in other of the accessed queues; and
populate the identified queue with an entry for the consumer requesting the consultation.

29. The computer program product of claim 28, further comprising instructions to:
determine that the entry for the consumer requesting the consultation is first in the identified queue; and
cause a communication channel to be established between the device used by the consumer and a device used by the service provider associated with the identified queue.

30. The computer program product of claim 28 wherein a service provider is available when associated with one or more of an available-web state, an available-telephone state, a busy-waiting room open state, an on-call state, and a busy state.
